(19) United States
(12) Patent Application Publication
(10) Pub. No.: US 2013/0110768 A1
(43) Pub. Date: May 2, 2013

(54) METHOD FOR MANAGING DATA, MEDIUM, AND APPARATUS FOR MANAGING DATA

(71) Applicant: Takuya SAKAMOTO, Kawasaki (JP)

(72) Inventor: Takuya SAKAMOTO, Kawasaki (JP)

(73) Assignee: FUJITSU LIMITED, Kawasaki-shi (JP)

(21) Appl. No.: 13/592,558

(22) Filed: Aug. 23, 2012

(30) Foreign Application Priority Data
Oct. 31, 2011 (JP) 2011-239448

(51) Int. Cl. G06F 17/30

(52) U.S. Cl. 707/609; 707/E17.005

(57) ABSTRACT

A method for managing data includes obtaining output device information from an external device, the output device information concerning an output device to which the external device outputs data, upon detecting access to the data stored in a storage device from the external device, estimating, using a processor, a first user who has viewed the data output to the output device based on a relationship for each of the output device information between the first user and a second user who uses the external device, and generating association information which associates the data with identification information identifying the first user to store the association information in the storage device.

### CROSS-REFERENCE TO RELATED APPLICATION

This application is based upon and claims the benefit of priority of the prior Japanese Patent Application No. 2011-239448, filed on Oct. 31, 2011, the entire contents of which are incorporated herein by reference.

### FIELD

The embodiments discussed herein are related to a method for managing data, a medium, and an apparatus for managing data.

### BACKGROUND

In daily operation, data such as electronic data created, such as files, is generally shared and reused. For example, files such as materials for a meeting are shared using a file server or the like. The shared files are viewed and new materials based on the viewed files are created, as desired. When a file created by someone else is to be reused, the desired file may be retrieved from a large number of files stored in the file server.

To facilitate retrieval of the desired file, files are managed by, for example, assigning a file name to each file to help identify the content of the file or creating a folder for each project, group, or meeting.

To facilitate retrieval of the desired file, furthermore, files are associated with keywords as metadata in addition to information such as the names of persons who create or update the files and dates or times when the files are created or updated, and the desired file is searched for using the metadata.

In connection with the techniques described above, a file server for identifying user identifiers included in file access requests from terminals is utilized.

A recording device for recording content in association with the attributes of the content and information concerning relevant persons when the content is recorded is also utilized.

An information adding device for adding metadata to captured image data, in which metadata is refined to make it easy for users to add the metadata to the captured image data is also utilized.

An information search device that uses previous search operation information extracted from access records to facilitate a search for association information is also utilized. The information search device segments the access records into a plurality of clusters. Further, the information search device ranks documents included in each cluster by frequency of access, and displays documents that are accessed more frequently as being more useful on a screen.

In addition, a method for the generation and use of context data in which context data representing relationships between pieces of content is generated and is shared by a plurality of users is utilized.

Following are examples of related art: Japanese Laid-open Patent Publication No. 02-004037, Japanese Laid-open Patent Publication No. 2005-110869, Japanese Laid-open Patent Publication No. 2008-270975, Japanese Laid-open Patent Publication No. 10-011458, and Japanese Laid-open Patent Publication No. 2002-251311.

### SUMMARY

According to an aspect of the invention, a method for managing data includes obtaining output device information from an external device, the output device information concerning an output device to which the external device outputs data, upon detecting access to the data stored in a storage device from the external device, estimating, using a processor, a first user who has viewed the data output to the output device based on a relationship for each of the output device information between the first user and a second user who uses the external device, and generating association information which associates the data with identification information identifying the first user to store the association information in the storage device.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram depicting an electronic data management apparatus 100;

FIG. 2 is a diagram illustrating an example configuration of an information sharing system including a file management server;

FIG. 3 is a diagram illustrating an example of output device information;

FIG. 4 is a diagram illustrating an example of a viewing-user determination method table;

FIG. 5 is a diagram illustrating an example of schedule information;

FIG. 6 is a diagram illustrating an example of file management information;

FIG. 7 is a diagram illustrating an example of user position information;

FIG. 8 is a diagram illustrating an example of a metadata table;

FIG. 9 is a flowchart illustrating a file management process performed by the file management server;

FIG. 10 is a diagram depicting an example of device information;

FIG. 11 is a flowchart illustrating a process for generating output device information;

FIG. 12 is a diagram illustrating a specific example of a process of the file management server;

FIG. 13 is a diagram illustrating a specific example of the process of the file management server;

FIG. 14 is a flowchart illustrating a search process performed by the file management server; and

FIG. 15 is a diagram illustrating an example configuration of the file management server.

### DESCRIPTION OF EMBODIMENTS

In the management of files using file names, folder names, metadata, and the like, file names of files created by different individuals, folder names of folders created by different individuals, and metadata created by different individuals may involve variation in expression. Thus, such file names, folder names, metadata may not necessarily be appropriate as the keywords used for a search.

The automatic creation of file names, folder names, and metadata under a certain rule is conceivable. In this case, metadata is created using, for example, information obtained when a file is created, information obtained by direct access to a file, or similar information. However, it is difficult for a user to add metadata which is considered desired by the user to a file created by another user, that is, a file that the user has not yet accessed directly.

For example, it is difficult for a user to add metadata indicating a user-viewed material to data of each of the materials on a projector which the user viewed in a meeting to allow the user to search for a desired one of the materials on the projector in the meeting. For this reason, it is difficult for a user to retrieve a desired material using vague information such as “the user viewed a material in some meeting that took place last month”.

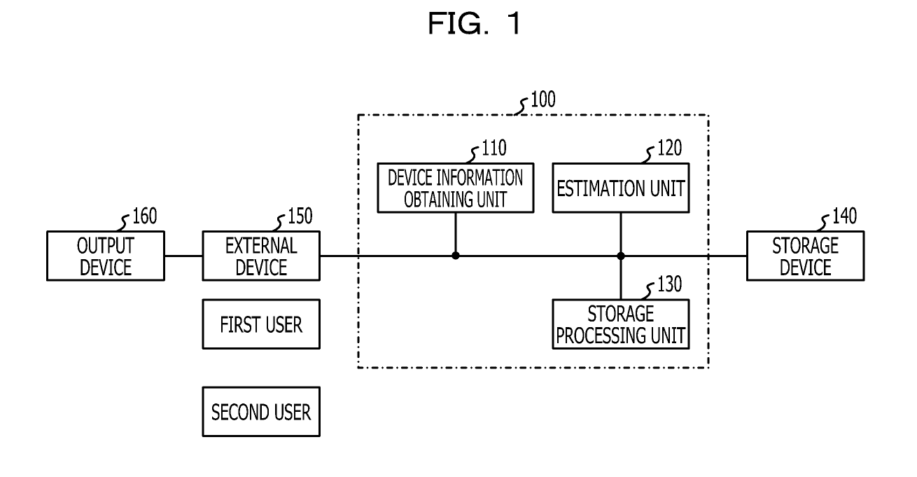

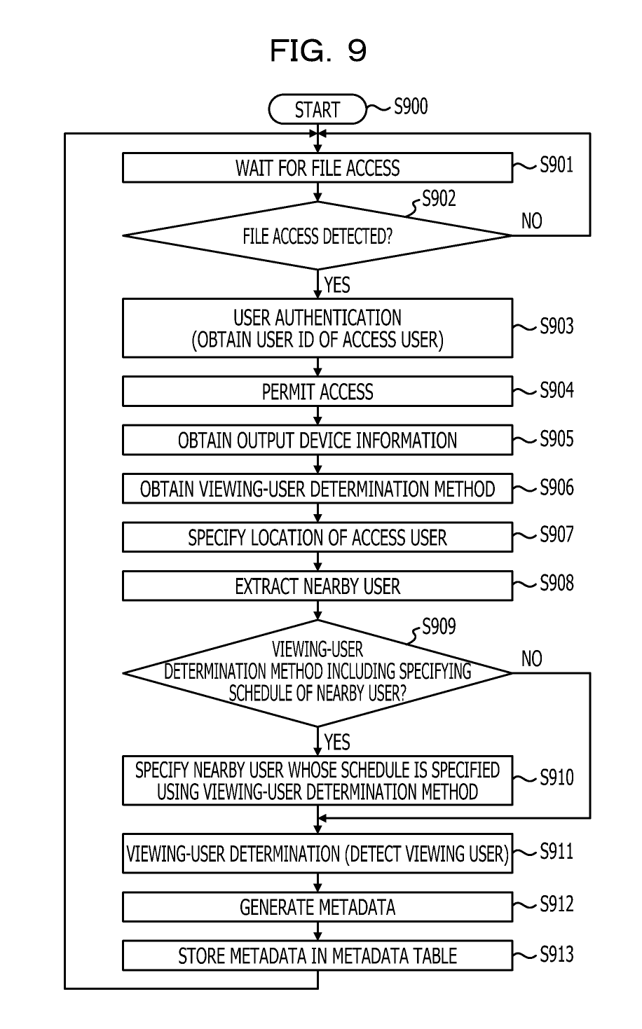

Embodiments will be described with reference to FIGS. 1 to 15. The following embodiments are illustrative and are not intended to exclude various modifications or techniques not expressly mentioned hereinafter. That is, the disclosed embodiments may be used in combination in various modified ways within the scope of the inventive concept herein taught. In addition, the processing procedures illustrated in flowchart form in FIGS. 9, 11, and 14 are not intended to limit the order of the processes. It is therefore to be understood that the processes may be reordered, if possible.

### Embodiment

FIG. 1 is a diagram depicting an electronic data management apparatus 100 according to an embodiment.

The electronic data management apparatus 100 includes a device information obtaining unit 110, an estimation unit 120, and a storage processing unit 130. The device information obtaining unit 110, the estimation unit 120, and the storage processing unit 130 may be implemented by causing a central processing unit (CPU) (not illustrated) included in the electronic data management apparatus 100 to execute predetermined program instructions. Thus, the electronic data management apparatus 100 may be implemented using an information processing apparatus including general components.

Upon detecting access to electronic data stored in a storage device 140 from an external device 150, the device information obtaining unit 110 obtains, from the external device 150 that has accessed the electronic data, output device information including information concerning an output device 160 to which the external device 150 outputs desired electronic data.

The estimation unit 120 estimates a second user who has viewed electronic data output to the output device 160 from a relationship between a first user who uses the external device 150 and a user other than the first user in accordance with the output device information. The estimation unit 120 estimates a second user who has viewed electronic data that the first user output to the output device 160, for example, a projector.

The relationship between the first user and a user other than the first user, which is used for estimation, may include the distance between the first user and the user other than the first user, and the relationship between the location of the first user and the location of the user other than the first user. The storage processing unit 130 generates association information which associates electronic data with identification information identifying the second user estimated to have viewed the electronic data, and stores the association information in the storage device 140.

The storage device 140 is a storage device that stores electronic data. Examples of the storage device 140 may include a magnetic disk storage device.

The external device 150 is a device connected to the electronic data management apparatus 100 so as to be capable of communicating with the electronic data management apparatus 100 via wired or wireless connection, such as a personal computer (PC).

The output device 160 is a device connected to the external device 150, for example, a projector or an audio device such as a speaker. If a display is connected to the external device 150, the output device 160 may include the external device 150.

As described above, the electronic data management apparatus 100 estimates a second user who has viewed electronic data output to the output device 160 from a relationship between the first user and a user other than the first user in accordance with the output device information. Then, the electronic data management apparatus 100 generates association information which associates the electronic data with identification information identifying the second user estimated to have viewed the electronic data, and stores the association information in the storage device 140.

Accordingly, such association information allows easy search for electronic data even if the electronic data has been viewed by a second user. Therefore, the electronic data management apparatus 100 may provide an electronic data management method that facilitates a search for desired electronic data.

### Other Embodiments

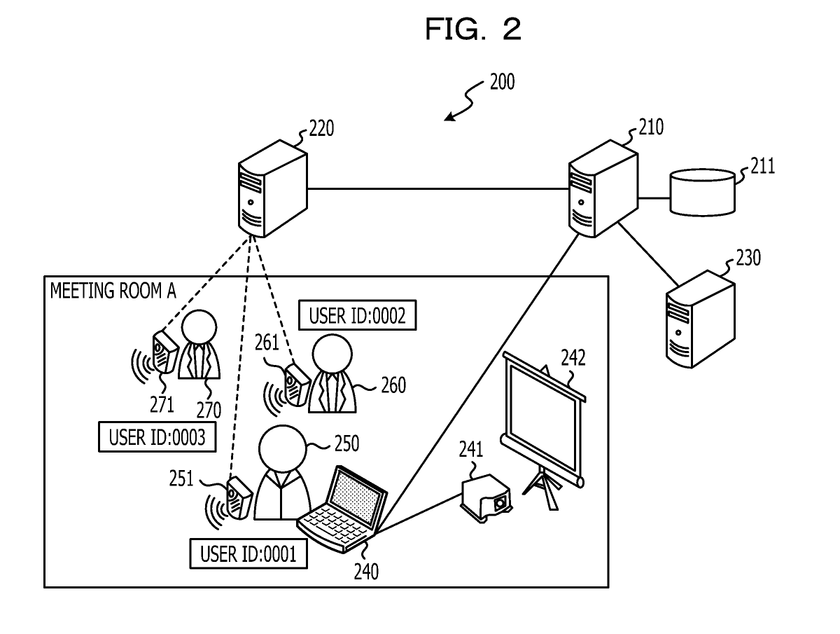

FIG. 2 is a diagram illustrating an example configuration of an information sharing system 200 including a file management server 210 according to another embodiment.

The information sharing system 200 includes the file management server 210, a position management server 220, and a scheduler 230.

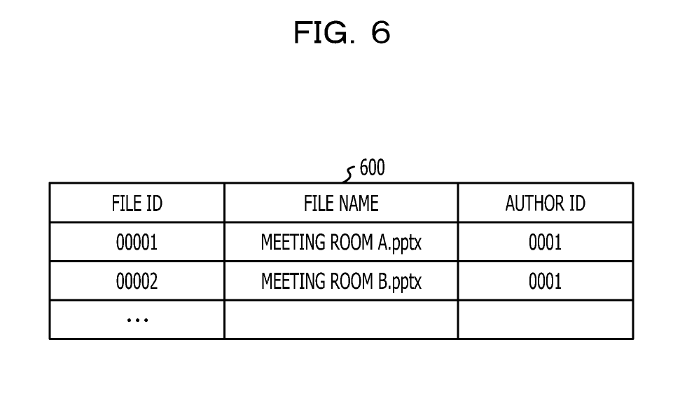

The file management server 210 is an information processing apparatus that stores electronic data such as electronic files in a storage device 211 and that manages the electronic data stored in the storage device 211. The electronic data stored in the storage device 211 may be managed using file management information 600, described below with reference to FIG. 6. In this embodiment, an electronic file is referred to simply as a “file”.

The file management server 210 uses a metadata table 800 including metadata for each file, as well as the file management information 600, to manage the electronic data stored in the storage device 211.

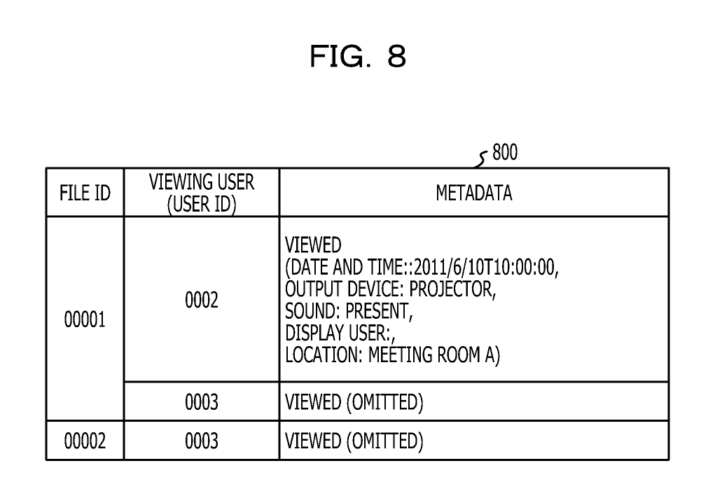

The metadata may include information concerning, for example, a user estimated to have viewed the associated file. The metadata table 800 will be described below with reference to FIG. 8.

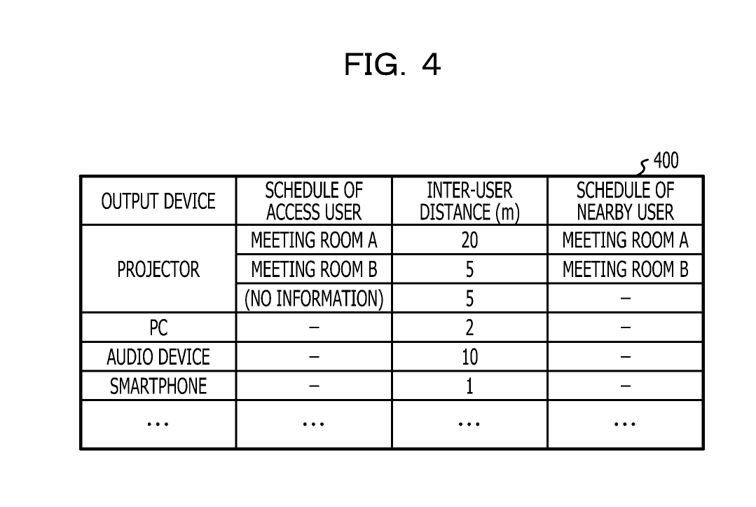

The file management server 210 uses a viewing-user determination method table 400 that is used to estimate a user who has viewed a file. The viewing-user determination method table 400 will be described below with reference to FIG. 4.

The file management server 210 includes the storage device 211 that stores files. The storage device 211 may be included in the file management server 210. The file management server 210 is connected to the position management server 220 or the scheduler 230 via a network so as to be capable of communicating with the position management server 220 or the scheduler 230. The file management server 210 is also connected to a PC 240 via a network so as to be capable of communicating with the PC 240.

In FIG. 2, the PC 240 is connected to the file management server 210, by way of example. However, the device connected to the file management server 210 is not limited to the PC 240. For example, the file management server 210 may include an interface that is connected to various devices such as a so-called smartphone and a mobile terminal having network connection capabilities so as to be capable of communicating with such devices. In this embodiment, devices that are connected to the file management server 210 so as to be capable of communicating with the file management server 210 are collectively referred to as “user terminals”.

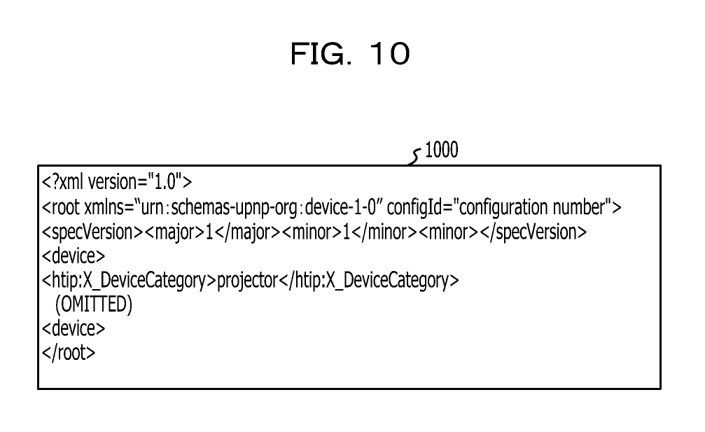

A user terminal and an output device connected to the user terminal, for example, a projector 241, are able to communicate with each other using a protocol based on the Universal Plug and Play (UPnP) standard. Further, the user terminal includes a storage device that stores device information 1000 including an identifier for identifying the user terminal. Also, an output device connected to the user terminal includes a storage device that stores device information 1000 including an identifier for identifying the output device. The device information 1000 will be described below with reference to FIG. 10.

The user terminal obtains the device information 1000 from the output device. The user terminal generates output device information 300 from the device information 1000 thereof and the device information 1000 obtained from the output device. The user terminal notifies the file management server 210 of the output device information 300 in response to a request from the file management server 210.

In FIG. 2, by way of example, the file management server 210, the position management server 220, the scheduler 230, and the PC 240 are connected via wired connection. However, they may be connected to one another via wireless connection.

The position management server 220 is an information processing apparatus that manages the positions of users 250, 260, and 270. The position management server 220 periodically communicates with communication terminals 251, 261, and 271 carried by the users 250, 260, and 270, respectively. Further, the position management server 220 obtains the current positions of the users 250, 260, and 270 from the communication terminals 251, 261, and 271, respectively.

The communication terminals 251, 261, and 271 store user IDs assigned to the users 250, 260, and 270 who carry the communication terminals 251, 261, and 271, respectively. Each of the communication terminals 251, 261, and 271 includes a Global Position System (GPS). For example, the communication terminals 251, 261, and 271 periodically use the GPS to specify the current positions of the users 250, 260, and 270. In response to a request from the position management server 220, each of the communication terminals 251, 261, and 271 notifies the position management server 220 of the associated user ID and the current position.

Each of the communication terminals 251, 261, and 271 may include a measurement unit that measures the radio field intensity of radio waves such as Wireless Fidelity (WiFi) or Bluetooth (registered trademark). In this case, each of the communication terminals 251, 261, and 271 periodically measures the radio field intensity of specific radio waves received from one or two or more relays. Further, each of the communication terminals 251, 261, and 271 specifies the current position based on the measured radio field intensity by using information obtained by measuring in advance the relationship between the radio field intensity of the specific radio waves received from each relay and the position at which the radio field intensity is obtained.

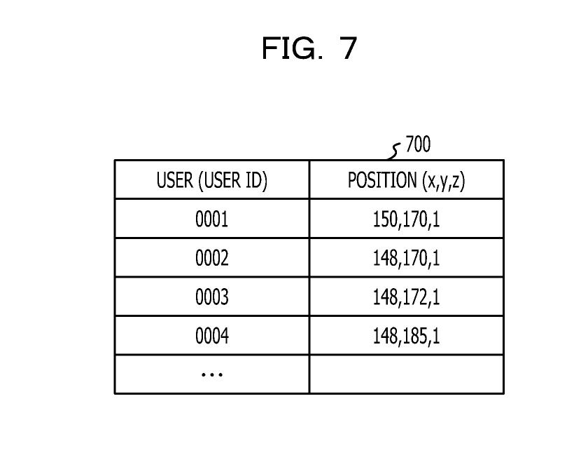

The position management server 220 creates user position information 700, described below with reference to FIG. 7, from the obtained positions of the users 250, 260, and 270.

In FIG. 2, for ease of illustration, three users 250, 260, and 270 are at Meeting Room A, by way of example. It is to be understood that this example is not intended to limit the number of users and the location at which the user or users are located.

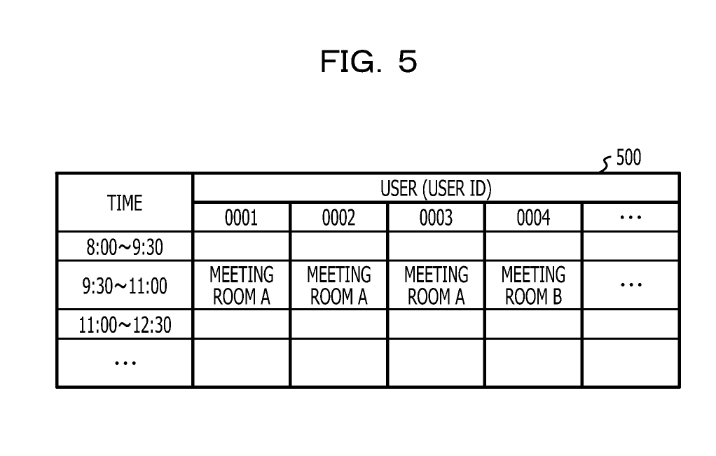

The scheduler 230 is an information processing apparatus that creates and stores schedule information 500 about the users 250, 260, and 270 in accordance with the input given by the users 250, 260, and 270. The schedule information 500 will be described below with reference to FIG. 5. The scheduler 230 updates the content of the schedule information 500 in accordance with the input given by the users 250, 260, and 270. Further, the scheduler 230 notifies the file management server 210 of the schedule information 500 in response to a request from the file management server 210.

In the above configuration, by way of example, the user 250 performs an operation for displaying a file A stored in the file management server 210 on a screen 242 using the projector 241 connected to the PC 240.

(1) The PC 240 accesses the file management server 210 through a certain operation of the user 250. Upon detecting access from the PC 240, the file management server 210 performs an authentication process to verify whether or not the accessing user is an authorized user who is authorized to access the files stored in the file management server 210. When the authenticity of the user is verified through the authentication process, the PC 240 obtains the file A from the file management server 210.

Users who have accessed the file management server 210 and who have been determined to be authorized users who are authorized to access the files stored in the file management server 210 are hereinafter referred to as “access users”. Examples of the user identification data (ID) of the access users may include the user ID input from the PC 240 during the authentication process.

(2) When the user 250 performs a certain operation, the PC 240 outputs the file A obtained from the file management server 210 to the projector 241. Then, the projector 241 displays the file A on the screen 242.

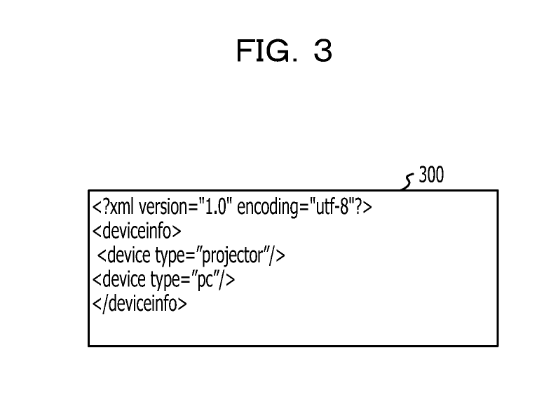

(3) The file management server 210 obtains output device information 300 from the PC 240 that has accessed the file management server 210. The output device information 300 is information concerning a device at the output destination to which the user terminal that has accessed the file management server 210, or in the example illustrated in FIG. 1, the PC 240, is allowed to output the file obtained from the file management server 210. Specific examples of the output device information 300 will be described with reference to FIG. 3.

(4) Upon obtaining the output device information 300, the file management server 210 obtains from the viewing-user determination method table 400 a viewing-user determination method for estimating a user who is viewing the file A displayed on the output device specified by the output device information 300.

(5) The file management server 210 obtains schedule information 500 from the scheduler 230. Further, the file management server 210 specifies the location at which an access user is located at the current time using the obtained schedule information 500.

(6) The file management server 210 obtains user position information 700 from the position management server 220. Further, the file management server 210 calculates the distance between an access user and another user. Then, the file management server 210 extracts a user for which the calculated distance falls within a range defined using the viewing-user determination method. The extracted user is referred to as a “nearby user”.

(7) The file management server 210 refers to the schedule information 500 and extracts a nearby user located in the same location as an access user. The extracted nearby user is referred to as a “viewing user”. The file management server 210 estimates that the viewing user will have viewed the file A that the access user displayed on the projector 241. The file management server 210 generates for each viewing user metadata including information indicating that the viewing user “has viewed the file A”. Further, the file management server 210 stores a viewing user, metadata including information indicating the viewing user “has viewed the file A”, and the file A in the metadata table 800 in association with one another.

In FIG. 2, the file management server 210, the position management server 220, and the scheduler 230 are separate devices, by way of example. However, the file management server 210 may include the functions of at least one of the position management server 220 and the scheduler 230.

FIG. 3 is a diagram illustrating an example of the output device information 300. Upon receiving a request for the output device information 300 from the file management server 210, a user terminal that has accessed the file management server 210, for example, the PC 240 illustrated in FIG. 2, creates output device information 300 and outputs the created output device information 300 to the file management server 210.

The output device information 300 illustrated in FIG. 3 is an example of the output device information 300 created using the Extensible Markup Language (XML).

The output device information 300 includes a <deviceinfo> tag. The <deviceinfo> tag includes one or two or more <device> tags. Each <device> tag has an attribute “type” representing an output device included in the associated user terminal. The output device may include a device capable of displaying a file among devices connected to the user terminal, for example, a projector or an audio device such as a speaker. If a display is connected to the user terminal, the output device may include the user terminal.

The output device information 300 illustrated in FIG. 3 is an example of output device information 300 including a “projector” and a “PC” as output devices.

FIG. 4 is a diagram illustrating an example of the viewing-user determination method table 400.

The viewing-user determination method table 400 illustrated in FIG. 4 defines, for each output device, a viewing-user determination method, that is, a determination method for determining a viewing user who is viewing the file displayed on the output device.

The viewing-user determination method may include the schedule of an access user, the inter-user distance, and the schedule of a nearby user. The schedule of an access user and the schedule of a nearby user may be represented as scheduled locations.

For example, in the example illustrated in FIG. 4, in the case where the output device is a projector, when the location of an access user is Meeting Room A, a user whose location is Meeting Room A among nearby users who are within a distance of 20 m from the access user is defined as a viewing user.

Also in the case where the output device is a projector, when the location of an access user is Meeting Room B, a user whose location is Meeting Room B among nearby users who are within a distance of 5 m from the access user is defined as a viewing user.

In FIG. 4, a dash (-) represents “not used” for viewing-user determination conditions.

For example, in the case where the output device is a projector, when there is no information concerning the schedule of an access user, a user who is within a distance of 5 m from the access user is defined as a viewing user.

The viewing-user determination method table 400 illustrated in FIG. 4 may further include a determination condition where the output of an audio device, which is an output device, is greater than or equal to a certain value. The reason is that if the output of an audio device connected to the user terminal is greater than or equal to a certain value, it is foreseeable that a presentation will be being made and therefore users within a certain range from the user terminal are watching the presentation.

The viewing-user determination method table 400 illustrated in FIG. 4 may further include an determination condition where the angles at which the users 250, 260, and 270 are oriented, which are obtained from user terminals such as smartphones or the communication terminals 251, 261, and 271, are within a certain value. The reason is that it is foreseeable that users oriented in different directions will not see the same object even if the users are close to one another.

In order to obtain information concerning the orientations of the users 250, 260, and 270 from the communication terminals 251, 261, and 271, the communication terminals 251, 261, and 271 may detect the orientations of the communication terminals 251, 261, and 271 using an acceleration sensor such as a gyro sensor.

FIG. 5 is a diagram illustrating an example of the schedule information 500.

The schedule information 500 illustrated in FIG. 5 stores the schedule of each user in steps of 90 minutes. The schedule may be represented as, for example, a scheduled location.

For example, the user with the user ID “0001”, the user with the user ID “0002”, and the user with the user ID “0003” are scheduled to be at Meeting Room A from 9:30 to 11:00. In addition, the user with the user ID “0004” is scheduled to be at Meeting Room B from 9:30 to 11:00.

FIG. 6 is a diagram illustrating an example of the file management information 600.

The file management information 600 illustrated in FIG. 6 is information including a file ID that is identification information identifying a file stored in the storage device 211, a file name of the file identified by the file ID, and an author ID that is a user ID of the user who created the file.

The file management information 600 illustrated in FIG. 6 includes, for example, the file with the file ID “00001” by way of example. The file with the file ID “00001” was created by the user with the user ID “0001”, and has a file name “meeting A.pptx”.

FIG. 7 is a diagram illustrating an example of the user position information 700.

The user position information 700 illustrated in FIG. 7 is information including a user ID and position information indicating the current position of the user having the user ID. The current position of a user may be the current position of a communication terminal carried by the user.

The user position information 700 illustrated in FIG. 7 includes, for example, the current position of the user with the user ID “0001”, by way of example. According to the user position information 700, the current position of the user with the user ID “0001” is represented by (x, y, z)=(150, 170, 1).

FIG. 8 is a diagram illustrating an example of the metadata table 800.

The metadata table 800 illustrated in FIG. 8 is information including a file ID, the user ID of a viewing user estimated to have viewed the file identified by the file ID, and metadata indicating that the viewing user has viewed the file.

The metadata includes a “viewed” tag indicating that the associated file has been viewed. The “viewed” tag may have various attributes added thereto, as desired, such as the “date and time” when the file was viewed, the “output device” on which the viewed file was displayed, the presence or absence of “sound”, “display user” indicating the user ID of a user who displayed the file, and the “location” where the file was displayed.

In FIG. 8, by way of example, the “viewed” tag includes attributes “date and time”, “output device”, “sound”, “display user”, and “location”. These are merely illustrative, and are not intended to limit the attributes included in the “viewed” tag.

FIG. 9 is a flowchart illustrating a file management process (step S900) performed by the file management server 210.

The file management server 210 waits for the file access from a user terminal connected to the file management server 210 so as to be capable of communicating with the file management server 210 via a wired or wireless network (step S901, NO in step S902).

Upon detecting file access from a user terminal (YES in step S902), the file management server 210 performs user authentication (step S903). In the user authentication, for example, the file management server 210 requests the user terminal to input a user ID and a password. If a user ID and a password which are input from the user terminal are included in a list of user IDs and a list of passwords stored in advance, the file management server 210 determines that the user ID input from the user terminal is the user ID of an authorized user. The file management server 210 uses the user ID input from the user terminal as the user ID of an access user.

Although not illustrated in FIG. 9, if it is determined in step S903 that the user ID input from the user terminal is not the user ID of an authorized user, the file management server 210 returns the process to step S901.

If it is determined that the user ID input from the user terminal is the user ID of an authorized user, the file management server 210 moves the process to step S904.

In step S904, the file management server 210 permits the user terminal to access the files stored in the file management server 210. The user terminal reads a file stored in the file management server 210 in accordance with a certain operation performed by the user, and displays the read file on the display of the user terminal or an output device connected to the user terminal, such as a projector.

In step S905, the file management server 210 obtains output device information 300 from the user terminal.

In step S906, the file management server 210 refers to the viewing-user determination method table 400 stored in the storage device 211. Then, the file management server 210 determines the viewing-user determination method corresponding to the output device specified by the output device information 300 obtained in step S905. If the viewing-user determination method table 400 defines a plurality of viewing-user determination methods associated with a specific output device, such as viewing-user determination methods for a projector as illustrated in FIG. 4, the file management server 210 uses a viewing-user determination method determined in accordance with the location of an access user.

In step S907, the file management server 210 obtains schedule information 500 from the scheduler 230. Then, the file management server 210 specifies the location at which an access user is located at the current time in accordance with the obtained schedule information 500. If the schedule information 500 does not include the location at which the access user is located at the current time, the file management server 210 determines that the schedule of the access user is unknown (no information).

In step S908, the file management server 210 obtains user position information 700 from the position management server 220. Then, the file management server 210 computes the distance between the position of an access user and the position of another user using the obtained user position information 700. Further, the file management server 210 extracts as a nearby user a user for which the computed distance is within an inter-user distance specified using the viewing-user determination method determined in step S906 from the user position information 700.

If in step S909, the viewing-user determination method determined in step S906 includes specifying the schedule of a nearby user (YES in step S909), the file management server 210 moves the process to step S910. In this case, the file management server 210 extracts a nearby user whose schedule matches the schedule of the nearby user specified using the viewing-user determination method determined in step S906, using the schedule information 500 obtained in step S907 (step S910). Then, the file management server 210 moves the process to step S911.

If the viewing-user determination method determined in step S906 does not include specifying the schedule of a nearby user (NO in step S909), the file management server 210 moves the process to step S911.

In step S911, the file management server 210 performs viewing-user determination in accordance with the viewing-user determination method determined in step S906, and detects a viewing user from the nearby users specified in step S908.

For example, a consideration will be given of a case where the output device specified by the output device information 300 obtained in step S905 is a projector and the location of the access user specified in step S907 is Meeting Room A. In this case, according to the viewing-user determination method table 400 illustrated in FIG. 4, in step S908, the file management server 210 extracts nearby users who are within an inter-user distance of 20 m. Then, the file management server 210 detects, as a viewing user, the nearby user specified in step S910, that is, a user whose location is Meeting Room A, among the nearby users extracted in step S908.

Further, a consideration will be given of a case where, for example, the output device specified by the output device information 300 obtained in step S905 is a projector and it is determined in step S907 that the schedule of an access user is unknown (no information). In this case, according to the viewing-user determination method table 400 illustrated in FIG. 4, in step S908, the file management server 210 extracts nearby users who are within an inter-user distance of 5 m. Then, the file management server 210 detects the nearby users extracted in step S908 as viewing users.

Further, a consideration will be given of a case where, for example, the output device specified by the output device information 300 obtained in step S905 is a PC. In this case, according to the viewing-user determination method table 400 illustrated in FIG. 4, in step S908, the file management server 210 extracts nearby users who are within an inter-user distance of 2 m. Then, the file management server 210 detects the nearby users extracted in step S908 as viewing users.

In step S912, the file management server 210 creates metadata for each of the viewing users detected in step S911. Then, in step S913, the file management server 210 stores the user ID of the viewing user and the metadata in the metadata table 800 in association with the file ID of a file that the viewing user is estimated to have viewed.

After the above process is completed, the file management server 210 returns the process step S901. Then, the file management server 210 starts the process from step S901.

As described with reference to FIG. 9, in this embodiment, the position management server 220 notifies the file management server 210 of the user position information 700 in accordance with a request from the file management server 210. However, the position management server 220 may obtain the user IDs of users who match the condition specified by the file management server 210, for example, the users ID of users having the same inter-user distance from a user having a specific user ID, from the user position information 700, and may notify the file management server 210 of the user IDs.

In this embodiment, furthermore, the scheduler 230 notifies the file management server 210 of the schedule information 500 in accordance with a request from the file management server 210. However, the scheduler 230 may obtain the location associated with the user ID and time specified by the file management server 210 from the schedule information 500, and may notify the file management server 210 of the obtained location. The scheduler 230 may also obtain the user ID of a user associated with the location and time specified by the file management server 210 from the schedule information 500, and may notify the file management server 210 of the obtained user ID.

FIG. 10 is a diagram depicting an example of device information 1000 stored in a user terminal and an output device connected to the user terminal. The device information 1000 may be implemented using the Device Description defined in the UPnP standard.

In this embodiment, the device information 1000 is implemented using a Device Description having an <htip:X_DeviceCategory> tag defining an identifier for a user terminal or an output device connected to the user terminal.

In FIG. 10, an example of a Device Description, which is device information 1000 stored in a projector, is illustrated.

The device Description illustrated in FIG. 10 defines a “projector” by the <htip:X_DeviceCategory> tag. The “projector” is an example of an identifier identifying a projector. However, the “projector” is an example of an identifier identifying a projector, and is not intended to limit the identifier identifying a projector to “projector”. An identifier of a user terminal or an output device connected to the user terminal may be defined using a character string or the like, as desired.

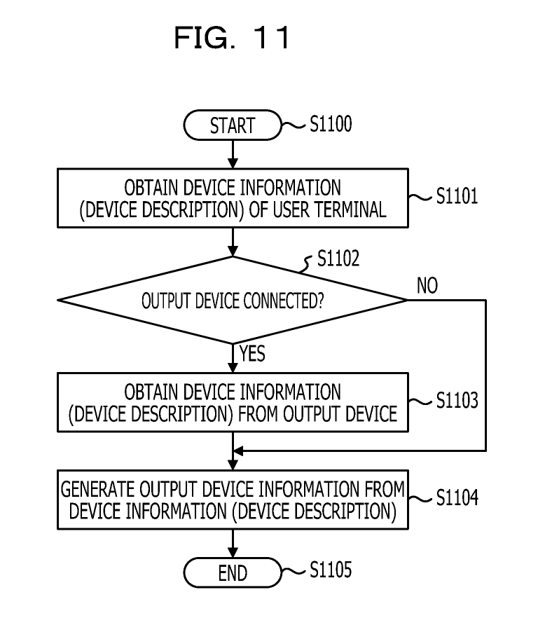

FIG. 11 is a flowchart illustrating a process (step S1100) for generating output device information 300 using a user terminal.

In this embodiment, communication is established between a user terminal and an output device using the UPnP standard. Thus, in FIG. 11, only processes to be used in this embodiment among the processes for communication established between a user terminal and an output device using the UPnP standard are illustrated.

In step S1101, the user terminal reads device information (Device Description) stored in a storage device included in the user terminal.

If an output device is connected to the user terminal (YES in step S1102), the user terminal moves the process to step S1103. In this case, the user terminal obtains device information 1000 from the output device (step S1103).

In step S1104, the user terminal generates output device information 300 from the device information 1000 obtained in step S1101 and the device information 1000 obtained in step S1103. In this case, the user terminal obtains an identifier defined by the <htip:X_DeviceCategory> tag from the device information 1000 obtained in step S1101 and the device information 1000 obtained in step S1103. Then, the user terminal generates output device information 300 including a <device> tag whose attribute type is the identifier defined by the <htip:X_DeviceCategory> tag.

When output device information 300 is generated, the user terminal stores the generated output device information 300 in the storage device included in the user terminal. Then, the user terminal terminates the process for generating the output device information 300 (step S1105).

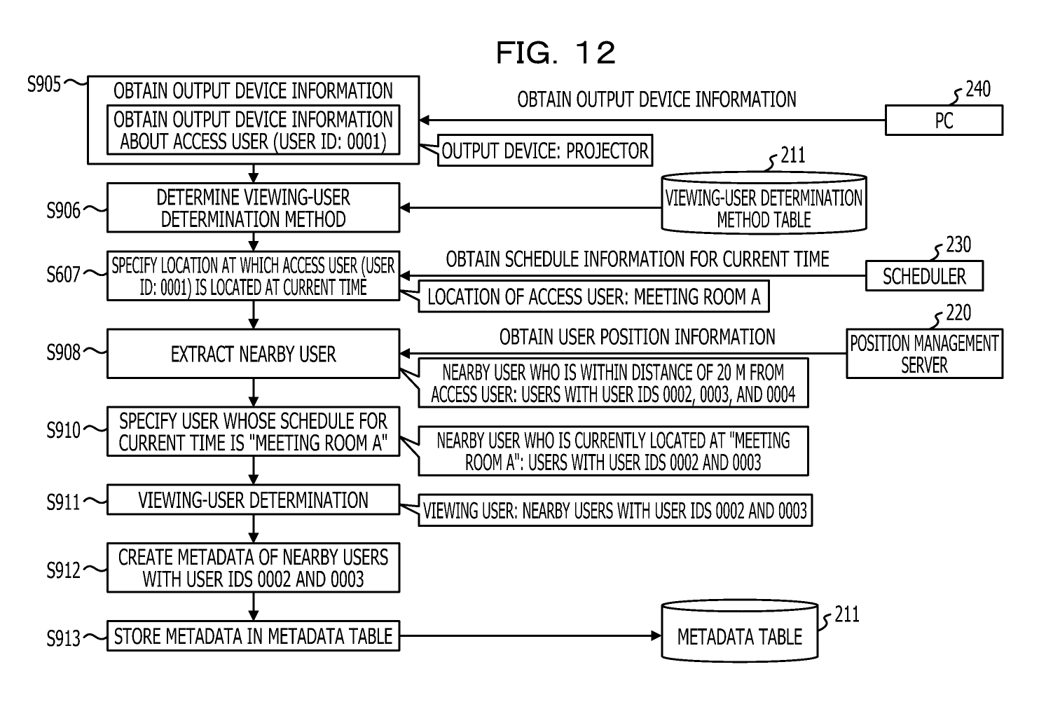

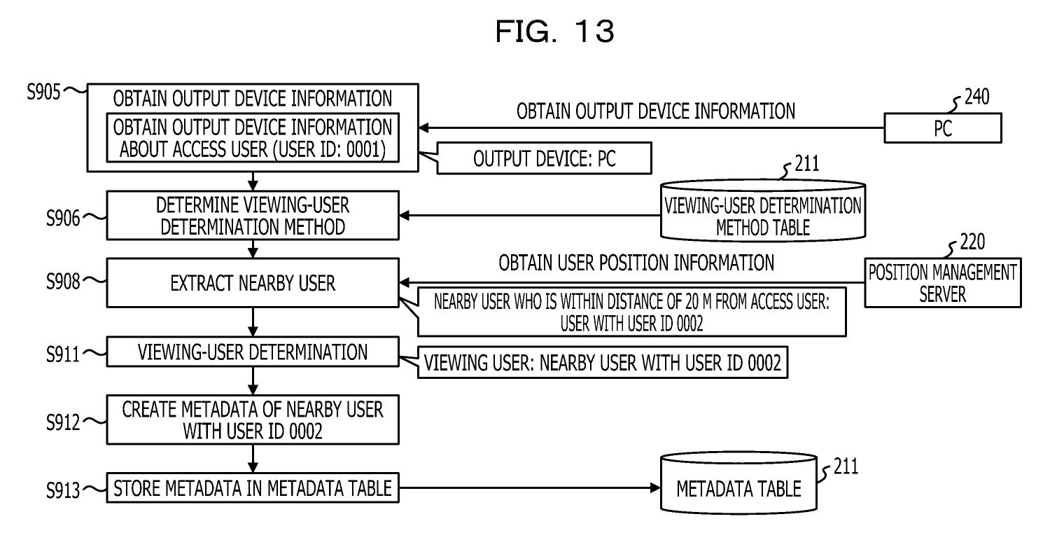

FIGS. 12 and 13 are diagrams illustrating a specific example of the process of the file management server 210.

FIG. 12 is a diagram depicting a process performed when the user with the user ID “0001” displays a file A stored in the file management server 210 on the screen 242 by using the projector 241 connected to the PC 240. In FIG. 12, steps S905 to S908 and S910 to S913 correspond to steps S905 to S908 and S910 to S913 illustrated in FIG. 9. However, steps S905 to S908 and S910 to S913 illustrated in FIG. 12 are not intended to limit steps S905 to S908 and S910 to S913 illustrated in FIG. 9.

In step S905, the file management server 210 obtains output device information 300 from the PC 240. Since a projector is connected to the PC 240, the file management server 210 obtains, for example, the output device information 300 illustrated in FIG. 3 from the PC 240.

As in FIG. 3, in the case where the output device information 300 includes two attribute types, e.g., “projector” and “PC”, the file management server 210 determines that the output device specified by the output device information 300 is a projector. If the output device information 300 includes a plurality of attribute types, an output device may be determined in accordance with predetermined priority.

In step S906, the file management server 210 refers to the viewing-user determination method table 400 stored in the storage device 211. Then, the file management server 210 determines a viewing-user determination method for the projector.

The viewing-user determination method table 400 illustrated in FIG. 4 includes a plurality of viewing-user determination methods for a projector. In this case, the file management server 210 uses a viewing-user determination method determined in accordance with the location of an access user.

In step S907, the file management server 210 obtains schedule information 500 for the current time from the scheduler 230. Then, the file management server 210 obtains the schedule of an access user from the schedule information 500.

In this embodiment, it is assumed that the current time is 10:00. In this case, the file management server 210 may obtain the schedule of the access user whose user ID is “0001”, that is, “Meeting Room A”, from the schedule information 500 illustrated in FIG. 5. In this case, the viewing-user determination method for the projector is a determination method based on the determination conditions in the top row of the viewing-user determination method table 400 illustrated in FIG. 4, that is, the determination conditions where the inter-user distance is within 20 m and the schedule of a nearby user is “Meeting Room A”.

In step S908, the file management server 210 obtains user position information 700 from the position management server 220, and extracts nearby users who are within a distance of 20 m from an access user.

For example, in the case of the user position information 700 illustrated in FIG. 7, nearby users who are within 20 m from the access user, i.e., the user with the user ID “0001, are the users with the user IDs “0002”, “0003”, and “0004”.

In step S910, the file management server 210 specifies a user whose schedule at the current time is “Meeting Room A” among the nearby users extracted in step S908 from the schedule information 500 obtained in step S907.

For example, in the case of the schedule information 500 illustrated in FIG. 5, the file management server 210 specifies the users with the user IDs “0002” and “0003” as nearby users whose schedule at the current time is “Meeting Room A”.

In step S911, the file management server 210 estimates, from the results in steps S908 and S910, that the nearby users with the user IDs “0002” and “0003” are viewing users.

In step S912, the file management server 210 creates metadata on the viewing users with the user IDs “0002” and “0003”. Then, in step S913, the file management server 210 stores the user IDs of the viewing users and the metadata in association with the file ID of the file that the viewing users are estimated to have viewed in the metadata table 800.

FIG. 13 is a diagram depicting a process performed when the user with the user ID “0001” displays a file A stored in the file management server 210 on the PC 240 to which no output devices are connected. In FIG. 13, steps S905 to S906, S908, and S911 to S913 correspond to steps S905 to S906, S908, and S911 to S913 illustrated in FIG. 9. However, steps S905 to S906, S908, and S911 to S913 illustrated in FIG. 13 are not intended to limit steps S905 to S906, S908, and S911 to S913 illustrated in FIG. 9.

In step S905, the file management server 210 obtains output device information 300 from the PC 240. Since no output devices are connected to the PC 240, the file management server 210 obtains output device information 300 including only the attribute type “PC” from the PC 240.

In step S906, the file management server 210 refers to the viewing-user determination method table 400 stored in the storage device 211. Then, the file management server 210 determines a viewing-user determination method for a PC. For example, if the viewing-user determination method table 400 illustrated in FIG. 4 is used, the viewing-user determination method for the PC is a determination method based on the determination conditions in the fourth row from the top, that is, the determination conditions for nearby users whose inter-user distance is within 2 m.

In step S908, the file management server 210 obtains user position information 700 from the position management server 220, and extracts nearby users who are within a distance of 2 m from an access user.

For example, in the case of the user position information 700 illustrated in FIG. 7, a nearby user who is within 2 m from the user with the user ID “0001”, who is an access user, is the user with the user ID “0002”.

In step S911, the file management server 210 estimates, from the result in step S908, that the nearby user with the user ID “0002” is a viewing user.

In step S912, the file management server 210 creates metadata on the nearby user with the user ID “0002”. Then, in step S913, the file management server 210 stores the user ID of the viewing user and the metadata in association with the file ID of the file that the viewing user is estimated to have viewed in the metadata table 800.

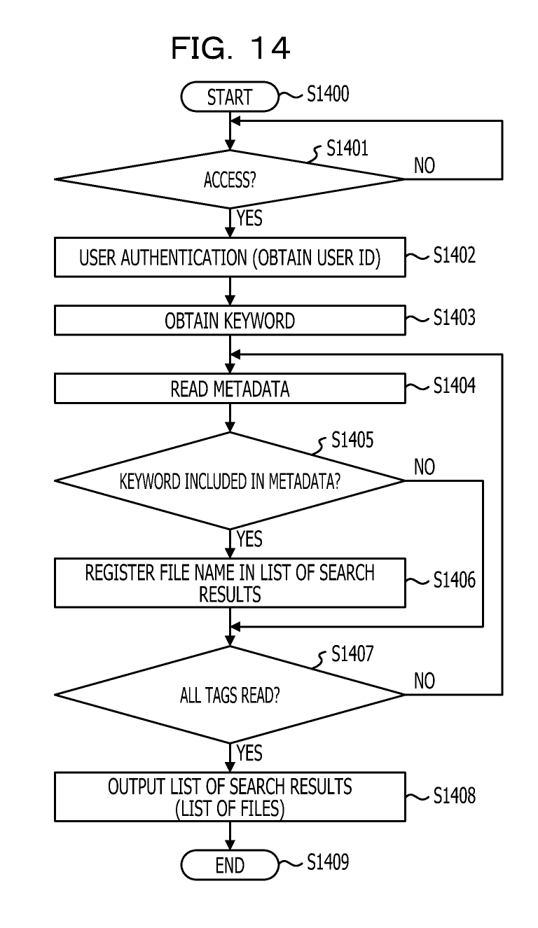

FIG. 14 is a flowchart illustrating a search process (step S1400) performed by the file management server 210.

The file management server 210 waits for the access from a user terminal connected to the file management server 210 so as to be capable of communicating with the file management server 210 via a wired or wireless network (NO in step S1401).

Upon detecting access from a user terminal (YES in step S1401), the file management server 210 performs user authentication (step S1402). In the processing of step S1402, processing similar to that of step S903 illustrated in FIG. 9 is performed. If the processing of step S1402 has already been performed for a certain period, the processing of step S1402 may be omitted.

In step S1403, the file management server 210 obtains a keyword input from the user terminal. Examples of the keyword may include the date and time when the file was viewed, the output device on which the viewed file was displayed, the user ID of the user who displayed the viewed file, and the location where the file was viewed.

In step S1404, the file management server 210 reads a piece of metadata on the viewing user whose user ID matches the user ID obtained in step S1402 from the metadata table 800.

If the piece of metadata read in step S1404 includes the keyword obtained in step S1403 (YES in step S1405), the file management server 210 moves the process to step S1406. In this case, the file management server 210 registers the file name of the file ID corresponding to the metadata read in step S1404 in a list of search results. Then, the file management server 210 moves the process to step S1407.

If the piece of metadata read in step S1404 does not include the keyword obtained in step S1403 (NO in step S1405), the file management server 210 moves the process to step S1407.

If in the metadata table 800, the metadata on the viewing user whose user ID matches the user ID obtained in step S1402 includes a piece of metadata that has not been read (NO in step S1407), the file management server 210 returns the process to step S1404.

If in the metadata table 800, all the pieces of metadata on the viewing user whose user ID matches the user ID obtained in step S1402 have been read (YES in step S1407), the file management server 210 moves the process to step S1408. In this case, the file management server 210 outputs a list of search results to the user terminal subjected to user authentication in step S1402.

When the above process is completed, the file management server 210 terminates the search process (step S1409).

In step S1403, the keyword “viewed” may be specified simply. The keyword “viewed” means that all the previously viewed files are to be searched. In this case, after the processing of step S1404 has been completed, the file management server 210 may move the process to step S1406 without performing the processing of step S1405.

As a result, through the processing of step S1406, all the files previously viewed by the user whose user ID matches the user ID obtained in step S1402 are registered in the list of search results. Then, the list of search results is output to the user terminal subjected to user authentication in step S1402 (step S1408).

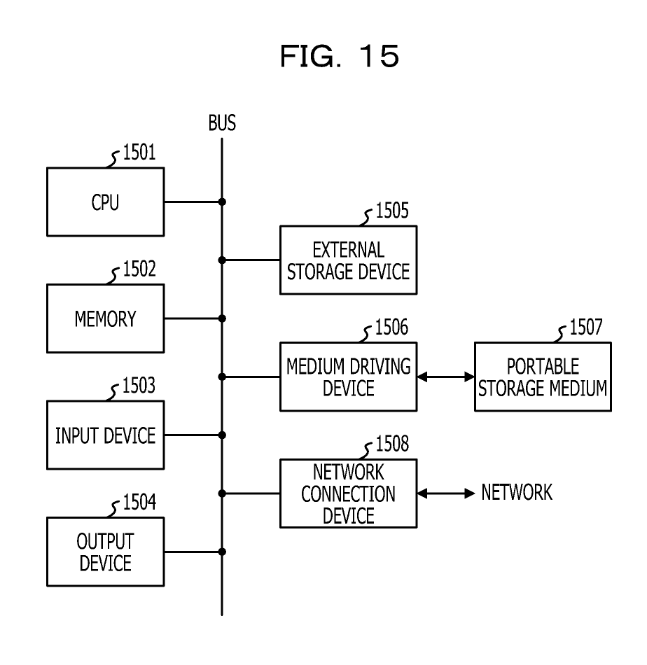

FIG. 15 is a diagram illustrating an example configuration of the file management server 210.

The file management server 210 includes a CPU 1501, a memory 1502, an input device 1503, an output device 1504, an external storage device 1505, a medium driving device 1506, and a network connection device 1508. The above devices are connected to a bus to mutually exchange data.

The CPU 1501 is an arithmetic unit that executes, in addition to a peripheral device and various pieces of software, a program for implementing file management according to this embodiment illustrated in FIGS. 9, 11 and 14, and the like.

The memory 1502 is a volatile storage device used to execute a program. Examples of the memory 1502 may include a random access memory (RAM).

The input device 1503 is an external data input device. Examples of the input device 1503 may include a keyboard and a mouse.

The output device 1504 is a device that outputs data and the like to a display device or the like. The output device 1504 may include a display device.

The external storage device 1505 is a storage device that stores programs or data to be used for the file management server 210 to operate, a program for implementing file management according to this embodiment, the viewing-user determination method table 400, the schedule information 500, the metadata table 800, and so forth. Examples of the external storage device 1505 may include a magnetic disk storage device. Examples of the external storage device 1505 may further include the storage device 211.

The medium driving device 1506 is a device that outputs the data stored in the memory 1502 or the external storage device 1505 to a portable storage medium 1507, such as a floppy disk, a magneto-optical (MO) disk, a compact disc recordable (CD-R), or a digital versatile disc recordable (DVD-R), or reads a program, data, and the like from the portable storage medium 1507.

The network connection device 1508 is a device connected to a network.

The configuration illustrated in FIG. 15 is an example of the file management server 210. Thus, the file management server 210 is not limited to the configuration illustrated in FIG. 15. The file management server 210 may be configured by removing unnecessary components from the components illustrated in FIG. 15 or adding new components not illustrated in FIG. 15, as desired. In addition, storage media readable by an information processing apparatus, such as the memory 1502, the external storage device 1505, and the portable storage medium 1507, may be implemented using non-transitory media.

As described above, the file management server 210 estimates a viewing user who has viewed a file output to an output device specified by the output device information 300 from the positional relationship between an access user and a nearby user, such as an inter-user distance, in accordance with a determined viewing-user determination method. Further, the file management server 210 stores the user ID of the viewing user and metadata in association with the file ID of the file that the viewing user is estimated to have viewed in the metadata table 800.

By using the metadata table 800, it is possible to easily search for a file using conditions such as the presence or absence of viewing, the date and time of viewing, an output device on which a viewed file was displayed, the user ID of a user who displayed the viewed file, and the location where the file was viewed.

That is, once a user merely views a file read from the storage device 211 and displayed on a user terminal or an output device connected to the user terminal, the user is able to easily search for the viewed file later.

In addition, once a user merely views a file read from the storage device 211 and displayed on a user terminal or an output device connected to the user terminal, the user is able to easily search for a desired file using vague memories such as the presence or absence of viewing and the date and time of viewing.

As described above, the file management server 210 may allow an easy search for a desired file.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A method for managing data, the method comprising:
obtaining output device information from an external device, the output device information concerning an output device to which the external device outputs data, upon detecting access to the data stored in a storage device from the external device;
estimating, by a processor, a first user who has viewed the data output to the output device based on a relationship for each of the output device information between the first user and a second user who uses the external device; and
generating association information which associates the data with identification information identifying the first user to store the association information in the storage device.

2. The method according to claim 1, wherein
the estimating includes
estimating the first user based on an estimation condition that defines for each of the output device information a positional relationship in which both of the first user and the second user located within a certain range from the first user are estimated to have viewed the data.

3. The method according to claim 1, further comprising:
searching for identification information that matches identification information identifying a third user within the identification information in the association information; and
outputting information concerning data associated with the identification information obtained in the searching.

4. The method according to claim 2, wherein
the positional relationship includes a relationship between a location of the first user and a location of the second user.

5. The method according to claim 2, wherein
the positional relationship includes a distance between the first user and the second user.

6. The method according to claim 2, wherein
the positional relationship includes both of a relationship between a location of the first user and a location of the second user and a distance between the first user and the second user.

7. The method according to claim 1, wherein
the association information associates the data, identification information identifying the first user, and the identification information identifying the second user with one another.

8. The method according to claim 1, wherein
the association information includes at least one of a date and time when the first user is estimated to have viewed the data, a location where the first user is estimated to have viewed the data, an output device to which the data was output, and whether or not audio has been output to the output device to which the data was output.

9. A computer-readable storage medium that stores a program, the program causing a computer to execute a process, the process comprising:
obtaining output device information from an external device, the output device information concerning an output device to which the external device outputs data, upon detecting access to the data stored in a storage device from the external device;
estimating a first user who has viewed the data output to the output device based on a relationship for each of the output device information between the first user and a second user who uses the external device; and
generating association information which associates the data with identification information identifying the first user to store the association information in the storage device.

10. An apparatus for managing data, the apparatus comprising:
a device information obtaining unit that obtains output device information from an external device, the output device information concerning an output device to which the external device outputs data, upon detecting access to the data stored in a storage device from the external device;
an estimation unit that estimates a first user who has viewed the data output to the output device based on a relationship for each of the output device information between the first user and a second user who uses the external device; and
a storage processing unit that generates association information which associates the data with identification information identifying the first user to store the association information in the storage device.

11. An apparatus for managing data, the apparatus comprising:
a memory; and
a processor coupled to the memory, the processor executing a process including
obtaining output device information from an external device, the output device information concerning an output device to which the external device outputs data, upon detecting access to the data stored in a storage device from the external device,
estimating a first user who has viewed the data output to the output device based on a relationship for each of the output device information between the first user and a second user who uses the external device, and
generating association information which associates the data with identification information identifying the first user to store the association information in the storage device.
